(19) United States
(12) Patent Application Publication
(10) Pub. No.: US 2014/0033984 A1
(43) Pub. Date: Feb. 6, 2014

(54) Water tank structure with wireless power transmission devices

(71) Applicant: FETON LIMITED, Taipei City (TW)

(72) Inventors: Chih Chun Li, Taipei (TW); Cheng Hsiu Wu, Taipei (TW)

(73) Assignee: FETON LIMITED, Taipei City (TW)

(21) Appl. No.: 13/924,843

(22) Filed: Jun. 24, 2013

(30) Foreign Application Priority Data
Jun. 25, 2012 (TW) 101212197

(51) Int. Cl. H01F 38/14; A01K 63/06; A01K 63/00

(52) U.S. Cl. CPC H01F 38/14; A01K 63/003; A01K 63/06
USPC 119/247

(57) ABSTRACT

A water tank structure with wireless power transmission devices is disclosed. The water tank structure includes a water tank, a passive device, and a transmitter. The passive device is disposed in the water tank and includes a receiver. The transmitter transmits electric energy to the receiver through resonance between the transmitter and the receiver. The transmitter transforms electricity first into electric signals and then into resonance energy, before transmitting the resonance energy. The receiver and the transmitter have corresponding characteristics in electrical resonance so that the receiver can receive the resonance signals output from the transmitter and then transform the resonance signals into electricity to be consumed by the electrical load of the passive device.

### BACKGROUND OF THE INVENTION

1. Technical Field

The present invention relates to a water tank structure with wireless power transmission devices and, more particularly, to a water tank structure employing wireless power transmission to supply electricity to electric devices.

2. Description of Related Art

The power consumed by a conventional water tank is generally supplied through a power line or power socket which directs electricity from either the mains electricity system or a power generator to the water tank. However, such wire-based power distribution is subject to restrictions of the water tank structure, and the water in the water tank may cause damage to the electric devices in the water tank or present electric leakage hazards, making it inconvenient or even impossible to set up wiring. In order to solve these problems, and based on the requirements of typical water tanks, the present invention provides an improved power transmission means for water tank structures used as aquariums or in garden decoration or landscaping.

### BRIEF SUMMARY OF THE INVENTION

The present invention relates to a water tank structure with wireless power transmission devices. The primary object of the present invention is to provide a water tank structure to which electric energy can be transmitted without using wires. More specifically, it is desirable that power can be transmitted to the electric devices in the water tank structure through wireless power transmission.

Another object of the present invention is to provide a water tank structure to which electric energy can be transmitted in the form of resonance energy without using wires. More specifically, it is desirable that the resonance energy transmitted by a transmitter outside the water tank can be directed into the water tank structure.

A further object of the present invention is to provide a water tank structure to which electric energy can be transmitted in the form of resonance energy without using wires, and which is also provided with an electric device for lighting.

A further object of the present invention is to provide a water tank structure to which electric energy can be transmitted in the form of resonance energy without using wires, and which is also provided with an ornament typically used in an aquarium, such as a decorative landscape, a decorative building, and a decorative cartoon character.

A further object of the present invention is to provide a water tank structure to which electric energy can be transmitted in the form of resonance energy without using wires, and which is also provided with an electric device applicable to an aquarium, such as a filtering device, an air pumping device, and an oscillator for generating bubbles, wherein the electric device supports wireless power transmission.

To achieve the above and other objects, the present invention discloses a water tank structure with wireless power transmission devices, wherein the water tank structure includes a water tank, a passive device, and a transmitter. The water tank is a container structure for holding water. The passive device is an electric device having an electrical load and includes a receiver, wherein the receiver includes a receiving circuit and a rectifying circuit. The transmitter includes a power supply, a resonance transmission driving circuit, and a transmitting circuit and can transmit electric energy to the receiver through resonance between the transmitter and the receiver. The passive device is provided in the water tank, and the transmitter is provided at a position where the effective range of the resonance energy transmitted by the transmitter covers the receiver. The power supply is a power source for supplying the electricity required for operations of the transmitter. The resonance transmission driving circuit is an electric signal regulating circuit configured to transform a portion of the electricity provided by the power supply into electric signals and output the electric signals to the transmitting circuit. The transmitting circuit can transform the electric signals generated by the resonance transmission driving circuit into resonance energy and transmit the resonance energy. The receiving circuit has electrical resonance characteristics corresponding to those of the transmitting circuit and is configured for transforming the resonance signals transmitted by and received from the transmitting circuit into electricity for output. The rectifying circuit is an electric signal regulating circuit for regulating and transforming the electricity output from the receiving circuit and then outputting electricity in the form required by the electrical load of the passive device.

In the foregoing water tank structure with the wireless power transmission devices, the transmitter may be provided at a bottom part, a top end, or a lateral part of the water tank. Alternatively, the transmitter may be provided adjacent to the water tank at such a position that the receiver is within the effective range of the resonance energy transmitted by the transmitter.

In the foregoing water tank structure with the wireless power transmission devices, the passive device further includes a light emitting element and a submersible light. The submersible light is a hollow waterproof box structure. The submersible light has a light permeable part made of a light permeable material and corresponding in position to the light emitting element. The light emitting element is an electrical load which can be electrically driven to emit light. The light emitting element is provided in the submersible light and corresponds to the light permeable part. The receiver is provided in the submersible light and electrically connected to the light emitting element of the passive device.

The foregoing submersible light may be a hollow waterproof box structure composed of an upper cover and a lower cover. The upper cover is provided at the top end of the lower cover such that the upper and lower covers form the hollow waterproof box structure. The light permeable part is provided on the upper cover.

The foregoing submersible light further includes an inner box. The inner box is a hollow structure with a through-hole post and is provided between the upper cover and the lower cover. The through-hole post is a tubular structure penetrated by a central through hole. The through-hole post extends upward from the top end of the inner box and corresponds in position to the light permeable part of the upper cover. The light emitting element and the receiver of the passive device are provided in the inner box. The light emitted by the light emitting element penetrates the upper cover through the light permeable part by way of the through-hole post.

In the foregoing water tank structure with the wireless power transmission devices, the transmitter further includes a first member, wherein the first member has a bottom cover at its bottom part and forms a transmitter receiving part. The first member is an element installed in the water tank. The transmitter receiving part is a hollow structure formed in the first member, and the bottom part of the transmitter receiving part is sealed by the bottom cover. The power supply, the resonance transmission driving circuit, and the transmitting circuit of the transmitter are provided in the transmitter receiving part of the first member.

The foregoing first member is located with respect to the water tank in such a way that the receiver, which is provided in the passive device, is within the effective range of the resonance energy transmitted by the transmitter and can receive the resonance energy transmitted by the transmitter.

The foregoing power supply of the transmitter is an alternating-current (A/C) power line. The power supply has one end extending outward and exposed outside the first member in order to electrically connect to the mains electricity system and thereby transmit A/C power from the mains electricity system to the transmitter.

In the foregoing water tank structure with the wireless power transmission devices, the passive device further includes a first ornament having a lower cover. The first ornament is provided at the top end of the lower cover to form a hollow waterproof box structure. The first ornament is at least partially made of a light permeable material and is shaped for decoration. The light emitting element and the receiver are provided between the first ornament and the lower cover and correspond to the light permeable portion of the first ornament.

In the foregoing water tank structure with the wireless power transmission devices, the passive device further includes a second ornament having a lower cover and multiple light guide members. The second ornament is provided at the top end of the lower cover to form a hollow waterproof box structure. Each of the light guide members is a cylinder made of a light conductive material. The light guide members penetrate and extend out of the second ornament from a position within the second ornament that corresponds to the light emitting element. The light emitting element and the receiver are provided between the second ornament and the lower cover and correspond to the light guide members of the second ornament.

In the foregoing water tank structure with the wireless power transmission devices, the passive device further includes a third ornament having a lower cover and a light permeable cover. The third ornament is provided at the top end of the lower cover and is a hollow box structure which is at least partially light-permeable. The light emitting element and the receiver are provided in the third ornament and correspond to the light permeable portion of the third ornament. The light permeable cover is a hollow structure made of a light permeable material and can enclose the third ornament. The light permeable cover includes a first light permeable cover and a second light permeable cover, each being a half-closed shell. The first light permeable cover and the second light permeable cover form a hollow waterproof structure once connected to each other.

The structure formed by the third ornament of the passive device and the light permeable cover of the third ornament can be designed in such a way that the specific gravity of the structure is close to or less than that of water.

In the foregoing water tank structure with the wireless power transmission devices, the passive device further includes a submersible pump. The submersible pump is an electrically driven water pumping device having a water tube and a filter. The water tube is in communication with the submersible pump and the filter. The filter is a filtering device provided on the water tank, and water filtered through the filter flows back into the water tank. The receiver is provided in the submersible pump of the passive device in a sealed and watertight manner and is electrically connected to the submersible pump to supply the electricity required by the submersible pump.

In the foregoing water tank structure with the wireless power transmission devices, the passive device further includes an air pump. The air pump is an electrically driven air pumping device having an air tube. The air tube is in communication with the air pump and extends above the water surface of the water tank so as for the air pump to draw air through the air tube and discharge the drawn air into the water tank. The receiver is provided in the air pump of the passive device in a sealed and watertight manner and is electrically connected to the air pump to supply the electricity required by the air pump.

In the foregoing water tank structure with the wireless power transmission devices, the passive device further includes an oscillator. The oscillator is a waterproof structure and an electrically driven oscillating device for generating bubbles. More specifically, the oscillator can generate ultrasonic energy and thereby excite the water in the water tank to form bubbles. The receiver is provided in and electrically connected to the oscillator to supply the electricity required by the oscillator.

The oscillator of the passive device has an oscillator upper cover and an oscillator lower cover, wherein the oscillator upper cover and the oscillator lower cover jointly form a waterproof box structure. The receiver and the oscillator are provided in the box structure formed by the oscillator upper cover and the oscillator lower cover.

The foregoing water tank structure with the wireless power transmission devices further includes a relay. The relay is a waterproof structure and an electric energy transmitting device configured to resonate with the transmitter. The relay receives the resonance energy transmitted by the transmitter and then transmits the received resonance energy to a remote electric device configured to resonate with the relay and thereby receive the resonance energy. The relay includes a relay circuit, wherein the relay circuit at least includes a relay coil. The relay coil receives the resonance energy provided by the resonance transmission driving circuit and then transmits the received energy in the form of resonance energy. The relay is provided in the water tank and within the effective range of the resonance energy transmitted by the transmitter, and the receiver of the passive device is disposed within the effective range of the resonance energy transmitted by the relay.

The foregoing relay further includes a relay upper cover and a relay lower cover. The relay upper cover is provided at the top end of the relay lower cover to form a waterproof box structure. The relay is provided in the box structure formed by the relay upper cover and the relay lower cover.

The foregoing relay may be provided in any element of the water tank.

The relay circuit of the relay is arranged in a specific pattern to form a resonance energy field featuring a specific distribution.

In the foregoing water tank structure with the wireless power transmission devices, the receiver, the transmitter, and the relay in each embodiment are compliant with the Qi standard of the Wireless Power Consortium.

In the foregoing water tank structure with the wireless power transmission devices, the receiver may be provided at a bottom part, a top end, or a lateral part of the water tank or in the vicinity of the water tank, provided that the receiver is within the effective range of the resonance energy transmitted by the transmitter.

The foregoing passive device further includes a water pump. The water pump is an electrically driven water pumping device having a water tube and a filter. The water pump is electrically connected to the receiver and in communication with the filter. The water tube is in communication with the water pump and the water tank. The filter is a filtering device provided on the water tank. The water pump draws the water in the water tank and directs the water to the filter, and water filtered through the filter flows back into the water tank.

The foregoing passive device may further include an air pump, wherein the air pump is provided on the water tank and is an electrically driven air pumping device having an air tube. The air tube is in communication with the air pump and extends below the water surface of the water tank. The air pump can draw air through the air tube and discharge the drawn air into the water tank.

The receiving circuit and the rectifying circuit of the receiver may be formed on a flexible circuit board. Moreover, the receiver as a whole may be formed as a waterproof structure.

### BRIEF DESCRIPTION OF THE SEVERAL VIEWS OF THE DRAWINGS

The objects as well as the technical features and effects of the present invention will be best understood by referring to the following detailed description of some illustrative embodiments and the accompanying drawings, in which:

FIG. 1 is an assembled perspective view of the water tank structure with wireless power transmission devices according to the first embodiment of the present invention;

FIG. 2 is an exploded perspective view of the embodiment shown in FIG. 1;

FIG. 3 schematically shows the electrical connections between certain elements of the present invention;

FIG. 4A is an assembled perspective view of certain elements of a water tank structure with wireless power transmission devices according to the present invention;

FIG. 4B is an exploded perspective view of the elements shown in FIG. 4A;

FIG. 5A is an assembled perspective view of certain elements of a water tank structure with wireless power transmission devices according to the present invention;

FIG. 5B is an exploded perspective view of the elements shown in FIG. 5A;

FIG. 6A is an assembled perspective view of the water tank structure with wireless power transmission devices according to the second embodiment of the present invention;

FIG. 6B is an exploded perspective view of certain elements of the embodiment shown in FIG. 6A;

FIG. 7A is an assembled perspective view of the water tank structure with wireless power transmission devices according to the third embodiment of the present invention;

FIG. 7B is an exploded perspective view of certain elements of the embodiment shown in FIG. 7A;

FIG. 8A is an assembled perspective view of the water tank structure with wireless power transmission devices according to the fourth embodiment of the present invention;

FIG. 8B is an exploded perspective view of certain elements of the embodiment shown in FIG. 8A;

FIG. 9 is an assembled perspective view of the water tank structure with wireless power transmission devices according to the fifth embodiment of the present invention;

FIG. 10 is an assembled perspective view of the water tank structure with wireless power transmission devices according to the sixth embodiment of the present invention;

FIG. 11A is an assembled perspective view of the water tank structure with wireless power transmission devices according to the seventh embodiment of the present invention;

FIG. 11B is an exploded perspective view of certain elements of the embodiment shown in FIG. 11A;

FIG. 12 is an assembled perspective view of the water tank structure with wireless power transmission devices according to the eighth embodiment of the present invention;

FIG. 13 is an exploded perspective view of certain elements of the embodiment shown in FIG. 12;

FIG. 14 schematically shows the electrical connections between certain elements of the embodiment depicted in FIG. 12;

FIG. 15 is an assembled perspective view of the water tank structure with wireless power transmission devices according to the ninth embodiment of the present invention; and

FIG. 16 schematically shows the electrical connections between certain elements of the embodiment depicted in FIG. 15.

### DETAILED DESCRIPTION OF THE INVENTION

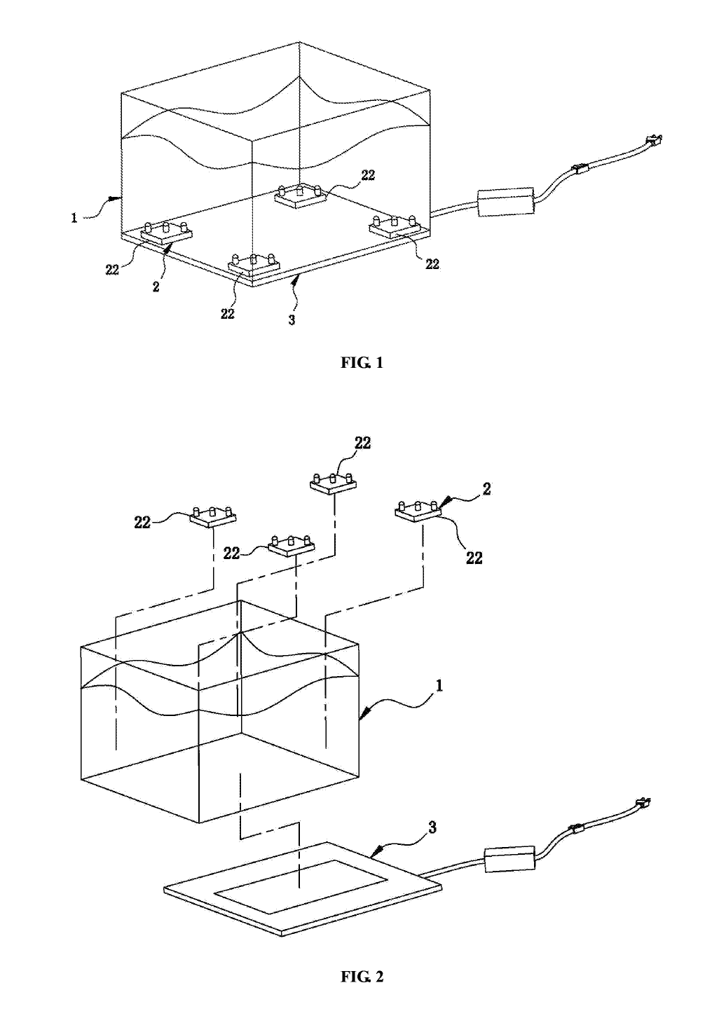

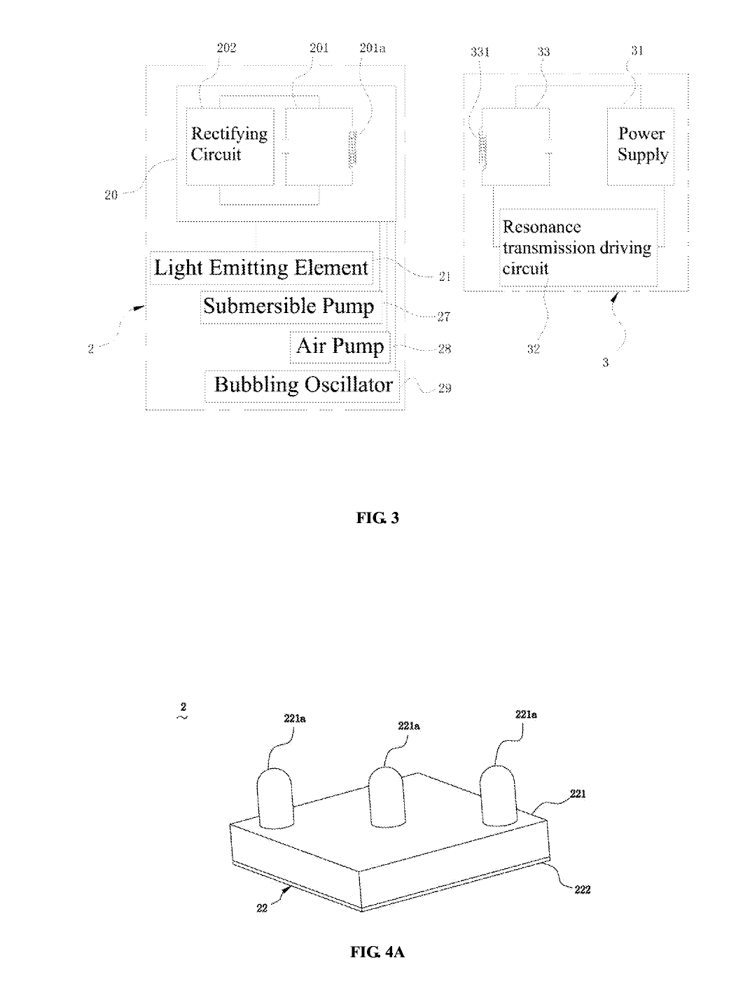

The present invention discloses a water tank structure with wireless power transmission devices. The water tank structure is equipped with power transmission devices which can transmit electric energy based on the resonance of electric signals so that electricity can be wirelessly transmitted to a load to drive the load into operation. FIG. 1 is an assembled perspective view of the water tank structure with wireless power transmission devices in the first embodiment of the present invention; FIG. 2 is an exploded perspective view of the embodiment shown in FIG. 1; and FIG. 3 schematically shows the electrical connections between certain elements of the present invention. Referring to FIGS. 1, 2, and 3, the water tank structure with the wireless power transmission devices includes a water tank 1, a passive device 2, and a transmitter 3. The water tank 1 is a container structure for holding water. The passive device 2 is a device having an electrical load and includes a receiver 20 for supplying the electricity required by the load of the passive device 2. The transmitter 3 is a device configured for transmitting electric energy through resonance and includes a power supply 31, a resonance transmission driving circuit 32, and a transmitting circuit 33. The power supply 31 is a power source for supplying the electricity required for operations of the transmitter 3. The resonance transmission driving circuit 32 is an electric signal regulating circuit configured for transforming a portion of the electricity provided by the power supply 31 into electric signals and for outputting the electric signals to the transmitting circuit 33. The transmitting circuit 33 at least includes a transmitting coil 331 which can transform the electric signals generated by the resonance transmission driving circuit 32 into resonance energy and then transmit the resonance energy. The receiver 20 is electrically connected to the electrical load of the passive device 2 and is an electric device which can receive resonance energy through wireless power transmission and can transform the resonance energy into electricity. The receiver 20 includes a receiving circuit 201 and a rectifying circuit 202. The receiving circuit 201, which corresponds to the transmitting circuit 33 of the transmitter 3, is a resonance circuit at least including a receiving coil 201a and is configured for receiving the resonance signals transmitted by the transmitting coil 331 of the transmitting circuit 33 and for transforming the resonance signals into electricity for output. The rectifying circuit 202 is an electric signal regulating circuit for regulating and transforming the electricity output from the receiving circuit 201 into the form of electricity that can be consumed by the electrical load of the passive device 2.

When the power supply 31 supplies the electricity required for operations of the transmitter 3, the resonance transmission driving circuit 32 transforms a portion of the electricity provided by the power supply 31 into electric signals and outputs the electric signals to the transmitting circuit 33. The transmitting coil 331 of the transmitting circuit 33 transforms the electric signals generated by the resonance transmission driving circuit 32 into resonance energy and transmits the resonance energy to the receiver 20. Then, the rectifying circuit 202 regulates and transforms the electricity output from the receiving circuit 201 into the form of electricity required by the passive device 2. The receiver 20 is disposed adjacent to the element of the water tank 1 that includes the transmitter 3. More particularly, the receiver 20 of the passive device 2 is disposed within the effective range of the resonance energy transmitted by the transmitter 3 in order to receive the resonance energy transmitted by the transmitter 3.

The transmitter 3 may be provided at a bottom part, a top end, or a lateral part of the water tank 1 or in the vicinity of the water tank 1, provided that the receiver 20 is within the effective range of the resonance energy transmitted by the transmitter 3 (to ensure that the receiver 20 can receive the resonance energy transmitted by the transmitter 3).

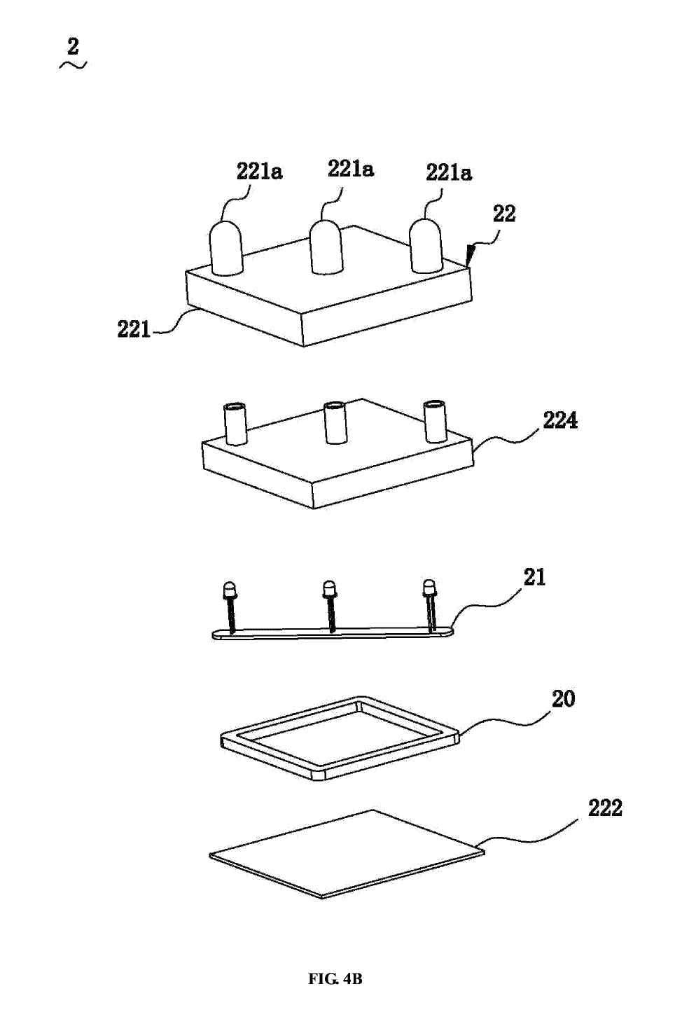

FIG. 4A is an assembled perspective view of certain elements of a water tank structure with wireless power transmission devices according to the present invention; and FIG. 4B is an exploded perspective view of the elements shown in FIG. 4A. Referring to FIGS. 4A and 4B with continued reference to FIGS. 1, 2, and 3, in the foregoing water tank structure with the wireless power transmission devices, the passive device 2 further includes a light emitting element 21 and a submersible light 22. The submersible light 22 is a hollow box structure composed of an upper cover 221 and a lower cover 222, wherein the upper cover 221 is provided at the top end of the lower cover 222 such that the two covers jointly form a hollow waterproof box structure. The upper cover 221 has a light permeable part 221a. The light permeable part 221a is made of a light permeable material and corresponds in position to the light emitting element 21. The light emitting element 21 is an electrical load which can be driven to emit light by electricity. The light emitting element 21 is provided between the upper cover 221 and the lower cover 222 and corresponds in position to the light permeable part 221a of the upper cover 221. The receiver 20 is provided between the upper cover 221 and the lower cover 222 and is electrically connected to the light emitting element 21 of the passive device 2. Thus, when the passive device 2 is disposed in the water tank 1 and within the effective range of the resonance energy transmitted by the transmitter 3, the receiver 20 can receive the resonance energy and transform it into electricity for use by the light emitting element 21 of the passive device 2. The light emitted by the light emitting element 21 penetrates the upper cover 221 through the light permeable part 221a thereof, providing a light source for lighting or for creating a decorative effect. Because the structure composed of the upper cover 221 and the lower cover 222 is sealed and waterproof, the light emitting element 21 and the receiver 20, both provided between the upper cover 221 and the lower cover 222, are protected from being damaged by the water in the water tank 1.

In the foregoing water tank structure with the wireless power transmission devices, the submersible light 22 further includes an inner box 224. The inner box 224 is a hollow structure with a through-hole post 224a and is provided between the upper cover 221 and the lower cover 222. The through-hole post 224a extends upward from the top end of the inner box 224, corresponds in position to the light permeable part 221a of the upper cover 221, and is a tubular structure penetrated by a central through hole. The light emitting element 21 and the receiver 20 of the passive device 2 are provided in the inner box 224. The light emitted by the light emitting element 21 penetrates the upper cover 221 through the light permeable part 221a by way of the through-hole post 224a.

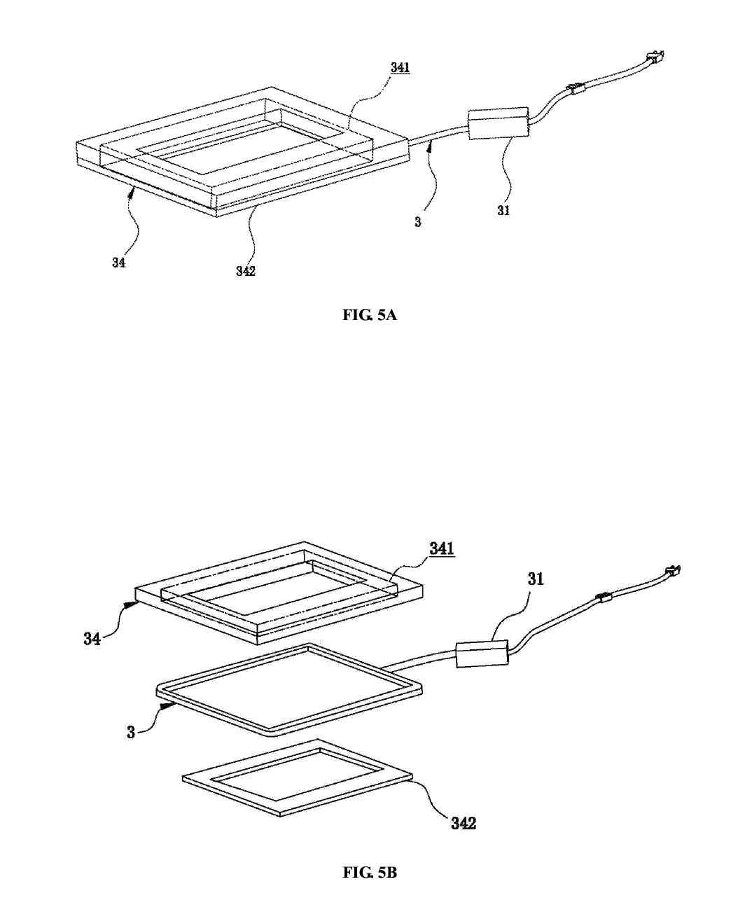

FIG. 5A is an assembled perspective view of certain elements of a water tank structure with wireless power transmission devices according to the present invention; and FIG. 5B is an exploded perspective view of the elements shown in FIG. 5A. Referring to FIGS. 5A and 5B with continued reference to FIGS. 1, 2, and 3, in the foregoing water tank structure with the wireless power transmission devices, the transmitter 3 further includes a first member 34, wherein the first member 34 is installed in the water tank 1, has a bottom cover 342 at the bottom part, and forms a transmitter receiving part 341. The transmitter receiving part 341 is a hollow structure formed in the first member 34, and the bottom part of the transmitter receiving part 341 is sealed by the bottom cover 342. The power supply 31, the resonance transmission driving circuit 32, and the transmitting circuit 33 of the transmitter 3 are provided in the transmitter receiving part 341 of the first member 34.

The first member 34 is disposed with respect to the water tank 1 in such a way that the receiver 20, provided in the passive device 2, is within the effective range of the resonance energy transmitted by the transmitter 3 and therefore can receive the resonance energy transmitted by the transmitter 3.

The power supply 31 of the transmitter 3 can be connected to an external power source to provide the electricity required by the transmitter 3.

In the foregoing embodiment, the power supply 31 of the transmitter 3 may be an A/C power line. In that case, the power supply 31 has one end extending outward and exposed outside the first member 34 in order to electrically connect to the mains electricity system and transmit A/C power from the mains electricity system to the transmitter 3 to support operations of the transmitter 3.

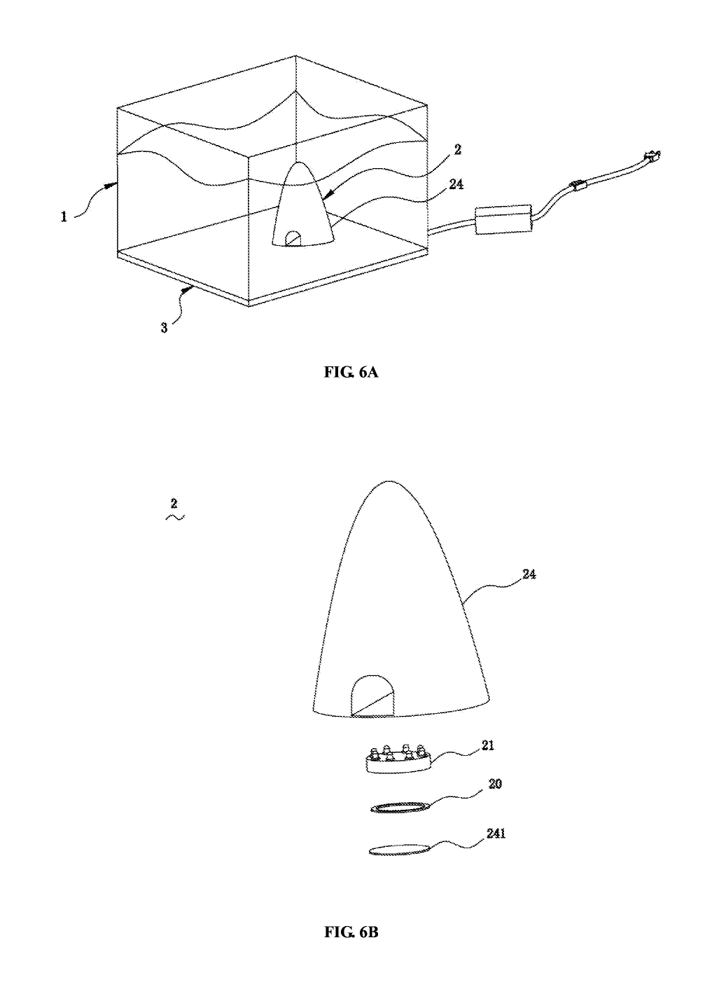

FIG. 6A is an assembled perspective view of the water tank structure with wireless power transmission devices according to the second embodiment of the present invention; and FIG. 6B is an exploded perspective view of certain elements of the embodiment shown in FIG. 6A. Referring to FIGS. 6A and 6B with continued reference to FIG. 3, in the foregoing water tank structure with the wireless power transmission devices, the passive device 2 further includes a first ornament 24 having a lower cover 241. The first ornament 24 is provided at the top end of the lower cover 241 such that the first ornament 24 and the lower cover 241 jointly form a hollow waterproof box structure. The first ornament 24 is at least partially made of a light permeable material. The light emitting element 21 and the receiver 20 are provided between the first ornament 24 and the lower cover 241 and correspond to the light permeable portion of the first ornament 24. Hence, when the passive device 2 is disposed in the water tank 1 and within the effective range of the resonance energy transmitted by the transmitter 3, the receiver 20 can receive the resonance energy and transform it into electricity for use by the light emitting element 21 of the passive device 2. The light emitted by the light emitting element 21 will penetrate the first ornament 24 and thereby enhance the decorative effect of the first ornament 24 in the water tank 1. In addition, the sealed waterproof structure formed by the first ornament 24 and the lower cover 241 can protect the light emitting element 21 and the receiver 20, both provided between the first ornament 24 and the lower cover 241, from being damaged by the water in the water tank 1.

The first ornament 24 is shaped for decoration and may take the form of a landscape, a building, a cartoon character, or any other decorative design typically used in an aquarium.

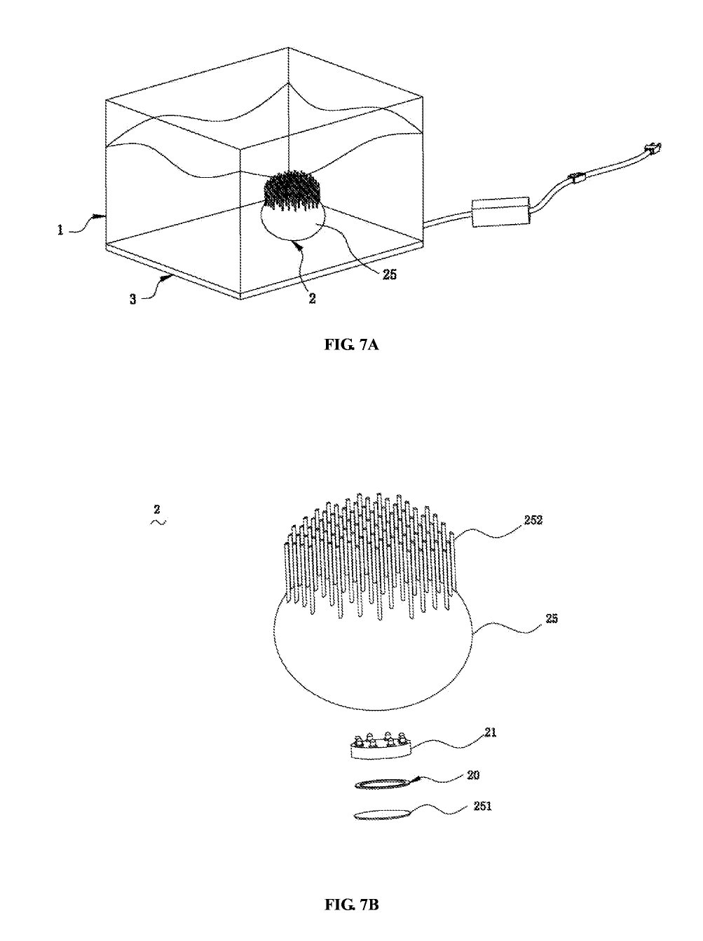

FIG. 7A is an assembled perspective view of the water tank structure with wireless power transmission devices according to the third embodiment of the present invention; and FIG. 7B is an exploded perspective view of certain elements of the embodiment shown in FIG. 7A. Referring to FIGS. 7A and 7B with continued reference to FIG. 3, in the foregoing water tank structure with the wireless power transmission devices, the passive device 2 further includes a second ornament 25 having a lower cover 251. The second ornament 25 is provided at the top end of the lower cover 251 such that the second ornament 25 and the lower cover 251 jointly form a hollow waterproof box structure. The second ornament 25 includes a plurality of light guide members 252, wherein each light guide member 252 is a cylinder made of a light conductive material. The light guide members 252 penetrate and extend out of the second ornament 25 from a position inside the second ornament 25 that corresponds to the light emitting element 21. The light emitting element 21 and the receiver 20 are provided between the second ornament 25 and the lower cover 251 and correspond to the light guide members 252 of the second ornament 25. Hence, when the passive device 2 is disposed in the water tank 1 and within the effective range of the resonance energy transmitted by the transmitter 3, the receiver 20 can receive the resonance energy and transform it into electricity for use by of the light emitting element 21 of the passive device 2. The light emitted by the light emitting element 21 will be guided out of the second ornament 25 through the light guide members 252 such that the light guide members 252 on the second ornament 25 produce a light emitting effect and thereby achieve their intended decorative effect in the water tank 1. In addition, the sealed waterproof structure formed by the second ornament 25 and the lower cover 251 can protect the light emitting element 21 and the receiver 20, both provided in the second ornament 25, from being damaged by the water in the water tank 1.

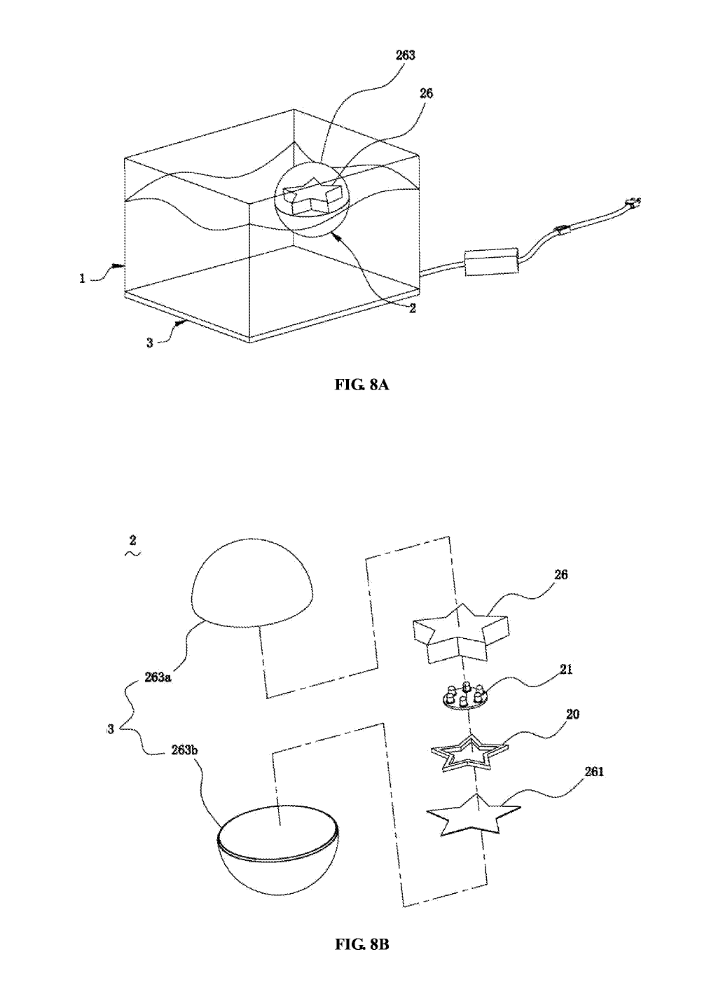

FIG. 8A is an assembled perspective view of the water tank structure with wireless power transmission devices according to the fourth embodiment of the present invention; and FIG. 8B is an exploded perspective view of certain elements of the embodiment shown in FIG. 8A. Referring to FIGS. 8A and 8B with continued reference to FIG. 3, in the foregoing water tank structure with the wireless power transmission devices, the passive device 2 further includes a third ornament 26, wherein the third ornament 26 is provided with a lower cover 261 and a light permeable cover 263. The third ornament 26 is provided at the top end of the lower cover 261 and is a hollow box structure which is at least partially light-permeable. The light emitting element 21 and the receiver 20 are provided in the third ornament 26 and correspond to the light permeable portion of the third ornament 26. The light permeable cover 263 is a hollow structure made of a light permeable material and can enclose the third ornament 26. The light permeable cover 263 includes a first light permeable cover 263a and a second light permeable cover 263b, wherein the first light permeable cover 263a and the second light permeable cover 263b are half-closed shells configured to form a hollow waterproof structure when connected together. Hence, when the passive device 2 is disposed in the water tank 1 and within the effective range of the resonance energy transmitted by the transmitter 3, the receiver 20 can receive the resonance energy and transform it into electricity for use by the light emitting element 21 of the passive device 2. The light emitted by the light emitting element 21 will pass through the third ornament 26 and the light permeable cover 263, allowing the third ornament 26 to produce its intended decorative effect in the water tank 1. In addition, the sealed waterproof structure formed by the first light permeable cover 263a and the second light permeable cover 263b of the light permeable cover 263 can protect the light emitting element 21 and the receiver 20, both provided in the third ornament 26, from being damaged by the water in the water tank 1.

In the foregoing fourth embodiment, the structure formed by the third ornament 26 of the passive device 2 and the light permeable cover 263 of the third ornament 26 can be so designed that the specific gravity of the structure is close to or less than that of water. For example, the light permeable cover 263 is designed as a hollow body with a sufficiently large internal volume, and the total weight of the light permeable cover 263 and the elements therein (i.e., the third ornament 26, the lower cover 261, the light emitting element 21, and the receiver 20) is controlled such that the specific gravity of the entire structure enclosed by the light permeable cover 263 of the third ornament 26 is close to or less than the specific gravity of water. Hence, once the third ornament 26 is disposed in the water tank 1, the third ornament 26 will float on the water surface of the water tank 1 and thereby achieve its intended decorative effect in the water tank 1.

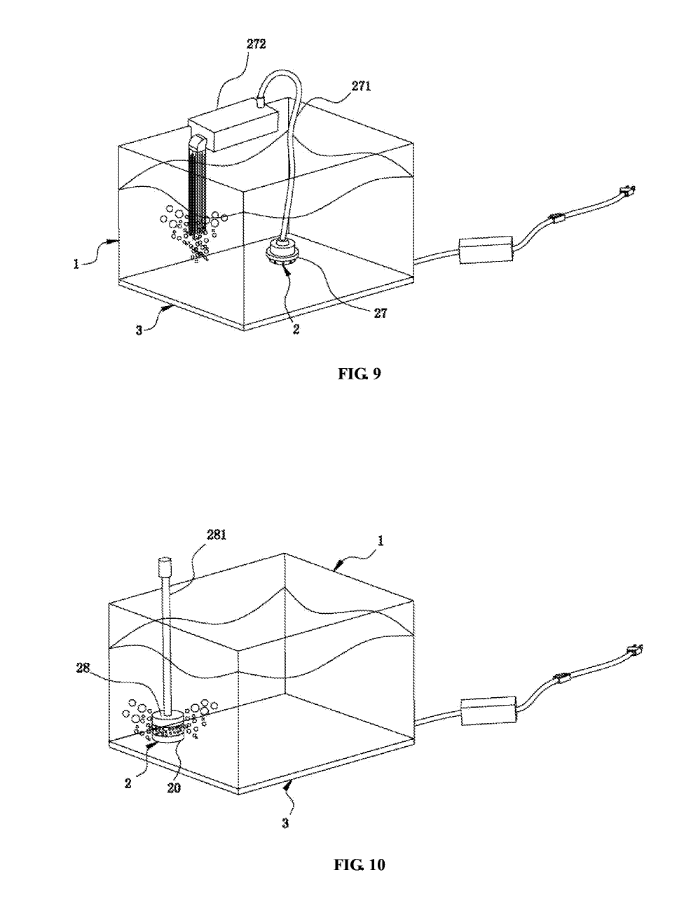

FIG. 9 is an assembled perspective view of the water tank structure with wireless power transmission devices according to the fifth embodiment of the present invention. Referring to FIG. 9 with continued reference to FIG. 3, in the foregoing water tank structure with the wireless power transmission devices, the passive device 2 further includes a submersible pump 27. The submersible pump 27 is an electrically driven water pumping device having a water tube 271 and a filter 272. The water tube 271 is in communication with the submersible pump 27 and the filter 272 such that the water discharged from the submersible pump 27 is directed to the filter 272. The filter 272, on the other hand, is a filtering device provided on the water tank 1, and water filtered through the filter 272 flows back into the water tank 1. Moreover, the receiver 20 is provided in the submersible pump 27 of the passive device 2 in a sealed and watertight manner, is electrically connected to the submersible pump 27, and can transform the received electric energy into the electricity required by the submersible pump 27. Hence, when the submersible pump 27 of the passive device 2 is disposed in the water tank 1 and within the effective range of the resonance energy transmitted by the transmitter 3, the receiver 20 can receive the resonance energy and transform it into electricity for use by the submersible pump 27 of the passive device 2. With the submersible pump 27 pumping water from the water tank 1 to the filter 272 through the water tube 271, the passive device 2 can filter out contaminants in the water. As the receiver 20 is provided in the submersible pump 27 in a sealed and watertight manner, the receiver 20 is protected from being damaged by the water in the water tank 1.

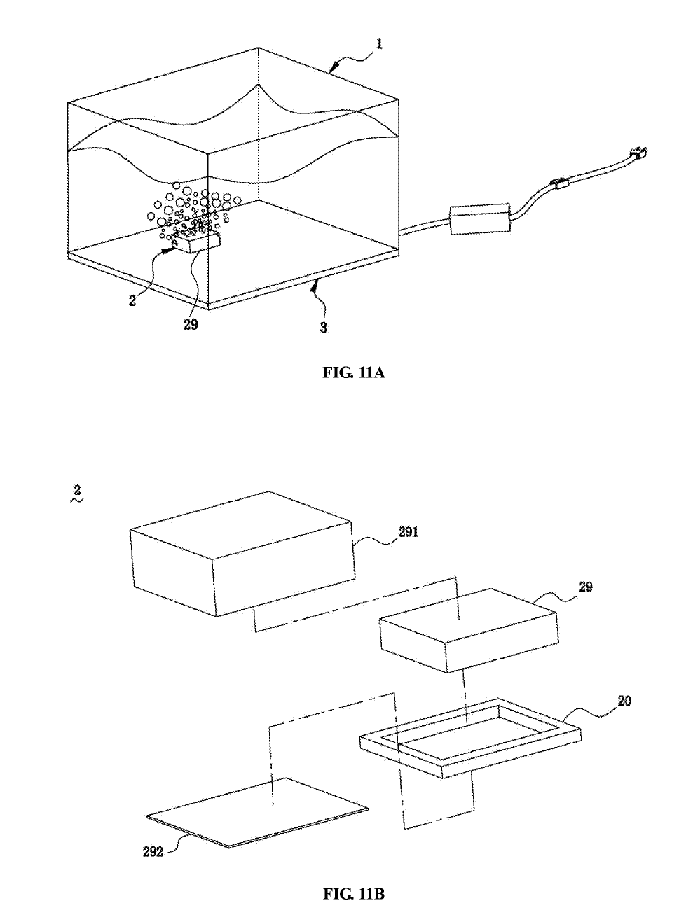

FIG. 10 is an assembled perspective view of the water tank structure with wireless power transmission devices according to the fifth embodiment of the present invention. Referring to FIG. 10 with continued reference to FIG. 3, in the foregoing water tank structure with the wireless power transmission devices, the passive device 2 further includes an air pump 28. The air pump 28 is an electrically driven air pumping device having an air tube 281. The air tube 281 is in communication with the air pump 28 and extends above the water surface of the water tank 1 so as for the air pump 28 to draw air and discharge the drawn air into the water tank 1. Furthermore, the receiver 20 is provided in the air pump 28 of the passive device 2 in a sealed and watertight manner and is electrically connected to the air pump 28. The receiver 20 can transform the received electric energy into the electricity required by the air pump 28. Hence, when the air pump 28 of the passive device 2 is disposed in the water tank 1 and within the effective range of the resonance energy transmitted by the transmitter 3, the receiver 20 can receive the resonance energy and transform it into electricity for use by the air pump 28 of the passive device 2. With the air pump 28 drawing air from outside the water tank 1 and pumping the air into the water tank 1 through the air tube 281, the passive device 2 can raise the dissolved oxygen level of the water in the water tank 1. As the receiver 20 is provided in the air pump 28 in a sealed and watertight manner, the receiver 20 is protected from being damaged by the water in the water tank 1.

FIG. 11A is an assembled perspective view of the water tank structure with wireless power transmission devices according to the seventh embodiment of the present invention; and FIG. 11B is an exploded perspective view of certain elements of the embodiment shown in FIG. 11A. Referring to FIGS. 11A and 11B with continued reference to FIG. 3, in the foregoing water tank structure with the wireless power transmission devices, the passive device 2 further includes an oscillator 29. The oscillator 29 is an electrically driven oscillating device for generating bubbles and has an oscillator upper cover 291 and an oscillator lower cover 292. The oscillator 29 can generate ultrasonic energy and thereby excite the water in the water tank 1 to form bubbles. The oscillator upper cover 291 and the oscillator lower cover 292 jointly form a waterproof box structure. The receiver 20 and the oscillator 29 are provided in the box structure formed by the oscillator upper cover 291 and the oscillator lower cover 292. The receiver 20 is electrically connected to the oscillator 29 and can transform the received electric energy into the electricity required by the oscillator 29. Hence, when the oscillator 29 is disposed in the water tank 1 and within the effective range of the resonance energy transmitted by the transmitter 3, the receiver 20 can receive the resonance energy and transform it into electricity for use by the oscillator 29 of the passive device 2. The oscillator 29, as stated above, generates bubbles by exciting the water in the water tank 1. When the bubbles brush against the surface of an object in the water bank 1, substances attached to the surface (not shown) can be scraped off. The removed substances can then be filtered out by a filter through which the water in the water tank 1 recycles. Thus, the passive device 2 helps clean the water tank 1. As the receiver 20 is provided in the passive device 2 in a sealed and watertight manner, the receiver 20 is protected from being damaged by the water in the water tank 1.

In addition, the bubbles generated in the water tank 1 by the oscillator 29 of the passive device 2 exciting the water in the water tank 1 provide a decorative effect in the water tank 1.

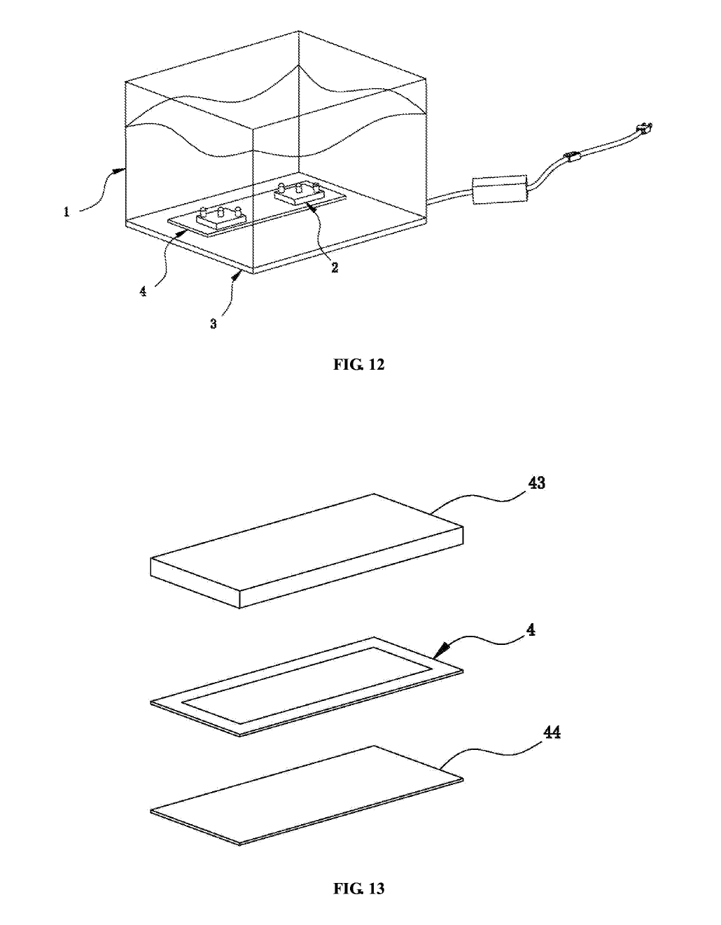

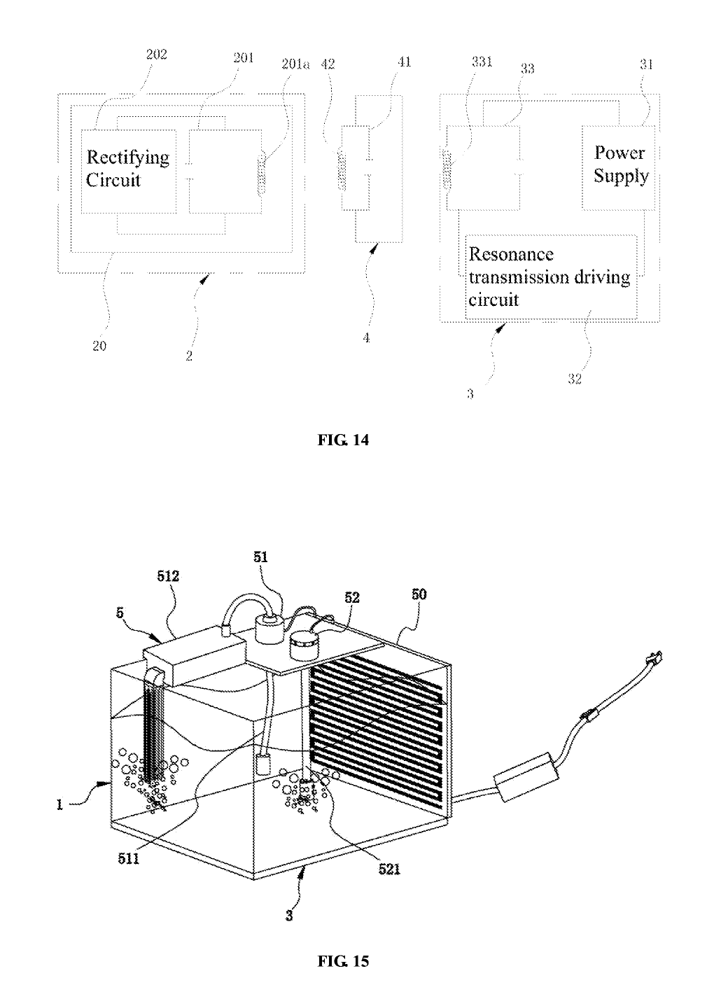

FIG. 12 is an assembled perspective view of the water tank structure with the wireless power transmission devices according to the eighth embodiment of the present invention; FIG. 13 is an exploded perspective view of certain elements of the embodiment shown in FIG. 12; and FIG. 14 schematically shows the electrical connections between certain elements of the embodiment depicted in FIG. 12. Referring to FIGS. 12, 13, and 14, the foregoing water tank structure with the wireless power transmission devices further includes a relay 4. The relay 4 is an electric energy transmitting device configured to resonate with the transmitter 3. The relay 4 can receive the resonance energy transmitted by the transmitter 3 and transmit the received resonance energy to a remote electric device configured for resonating with the relay 4 and thereby receiving the resonance energy. The relay 4 includes a relay circuit 41 which at least includes a relay coil 42. The relay coil 42 receives the resonance energy provided by the resonance transmission driving circuit 32 and then transmits the resonance energy. The relay 4 is provided in the water tank 1 and within the effective range of the resonance energy transmitted by the transmitter 3, and the receiver 20, which is provided in the passive device 2, is disposed within the effective range of the resonance energy transmitted by the relay 4 so that the receiver 20 can provide the electricity required by the passive device 2. Hence, when the power supply 31 supplies the electricity required for operations of the transmitter 3, the resonance transmission driving circuit 32 regulates the electricity received from the power supply 31 by transforming a portion of the received electricity into electric signals and outputs the electric signals to the transmitting circuit 33. Then, the transmitting coil 331 of the transmitting circuit 33 transforms the electric signals generated by the resonance transmission driving circuit 32 into resonance energy and transmits the resonance energy to the relay 4. The relay 4 receives the resonance energy and transmits it in the form of resonance energy. The receiver 20 receives the electric energy transmitted by the relay 4 and transforms the electric energy into the electricity required by the passive device 2. Therefore, through the assistance of the relay 4, the effective range of the resonance energy transmitted by the transmitter 3 is extended.

Furthermore, the relay 4 can be used in conjunction with the passive device 2 in each of the foregoing embodiments of the present invention.

The relay 4 may be a waterproof structure. The relay 4 further includes a relay upper cover 43 and a relay lower cover 44. The relay upper cover 43 is provided at the top end of the relay lower cover 44 such that the two covers jointly form a waterproof box structure. The relay 4 is provided in the box structure formed by the relay upper cover 43 and the relay lower cover 44 and thus becomes waterproof. Therefore, the relay 4 can be disposed directly in the water in the water tank 1, allowing the resonance energy transmitted by the transmitter 3 outside the water tank 1 to be directed to the passive device 2 in the water tank 1 through the relay 4.

In addition, in the foregoing embodiments of the water tank structure with the wireless power transmission devices, the relay 4 may be provided in any element of the water tank 1, provided that the relay 4 is disposed within the effective range of the resonance energy transmitted by the transmitter 3 and that the receiver 20, which is provided in the passive device 2, is disposed within the effective range of the resonance energy transmitted by the relay 4.

The relay 4 may be disposed in the water tank 1 or adjacent to the water tank 1, provided that the receiver 20 is located within the effective range of the resonance energy transmitted by the relay 4 and that the relay 4 is located within the effective range of the resonance energy transmitted by the transmitter 3 (to ensure that the relay 4 can receive the resonance energy transmitted by the transmitter 3 and that the receiver 2 can receive the resonance energy transmitted by the relay 4).

The relay circuit 41 of the relay 4 is arranged in a specific pattern so that the resonance energy transmitted by the relay 4 possesses a specific distribution and forms a field of resonance energy of the specific distribution. The pattern of the relay circuit 41 is intended for the receiver 20 to receive more electric energy or for the relay 4 to relay electric energy farther.

In each of the foregoing embodiments of the water tank structure with the wireless power transmission devices, the receiver 20, the transmitter 3, and the relay 4 are compliant with the Qi standard of the Wireless Power Consortium.

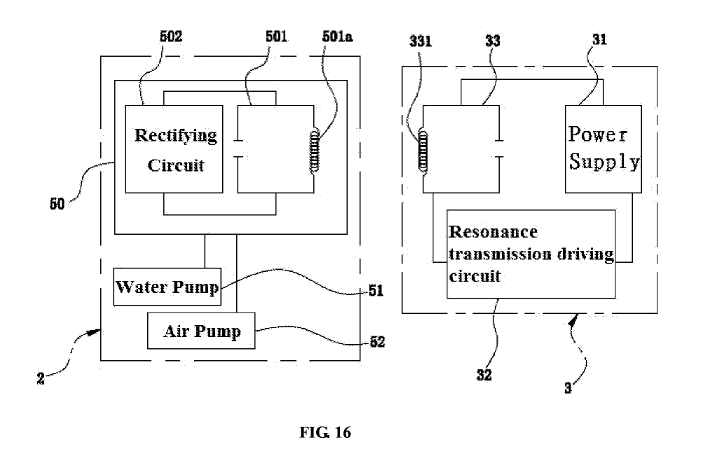

FIG. 15 is an assembled perspective view of the water tank structure with wireless power transmitting devices according to the ninth embodiment of the present invention; and FIG. 16 schematically shows the electrical connections between certain elements of the embodiment depicted in FIG. 15. Referring to FIGS. 15 and 16, the foregoing water tank structure with the wireless power transmission devices further includes a passive device 5. The passive device 5 includes a receiver 50 and a water pump 51, wherein the water pump 51 is an electrical load device electrically connected to the receiver 50, and the receiver 50 is provided on the water tank 1 and configured for supplying the electricity required by the water pump 51. The receiver 50 is an electric device configured for receiving resonance energy through wireless power transmission and for transforming the received resonance energy into electricity. The receiver 50 includes a receiving circuit 501 and a rectifying circuit 502. The receiving circuit 501 is a resonance circuit at least including a receiving coil 501a. The receiving circuit 501 corresponds to the transmitting circuit 33 of the transmitter 3 and can receive the resonance signals transmitted by the transmitting coil 331 of the transmitter 33 and transform the received resonance signals into electricity for output. The rectifying circuit 502 is an electric signal regulating circuit configured for regulating and transforming the electricity output from the receiving circuit 501 into the form of electricity required for operations of the water pump 51.

The receiver 50 may be provided at a bottom part, a top end, or a lateral part of the water tank 1 or in the vicinity of the water tank 1, provided that the receiver 50 is disposed within the effective range of the resonance energy transmitted by the transmitter 3 (to ensure that the receiver 50 can receive the resonance energy transmitted by the transmitter 3).

Moreover, the receiving circuit 501 and the rectifying circuit 502 of the receiver 50 may be formed on a flexible circuit board so that the receiver 50 can be attached to the surface of the water tank 1, even if the surface of the water tank 1 is curved.

Besides, the receiver 50 as a whole may be formed as a waterproof structure. In that case, the receiver 50 can be provided in the water tank 1, and yet the circuits of the receiver 50 are protected from being damaged by the water in the water tank 1.

The water pump 51 is an electrically driven water pumping device having a water tube 511 and a filter 512. The water pump 51 is in communication with the filter 512, and the water tube 511 is in communication with the water pump 51 and the water tank 1, so as for the water pump 51 to draw water from the water tank 1 and direct the drawn water to the filter 512. The filter 512 is a filtering device provided on the water tank 1, and the water filtered through the filter 512 flows back into the water tank 1. Hence, when the receiver 50 of the passive device 5 is disposed in the water tank 1 and within the effective range of the resonance energy transmitted by the transmitter 3, the receiver 50 can receive the resonance energy and transform it into electricity for use by the water pump 51 of the passive device 5. With the water pump 51 pumping water from the water tank 1 to the filter 512 through the water tube 511, the passive device 5 can filter out contaminants in the water.

With continued reference to FIGS. 15 and 16, in the foregoing water tank structure with the wireless power transmission devices, the passive device 5 further includes an air pump 52. The air pump 52 is an electrical load device electrically connected to the receiver 50, and the receiver 50 is provided on the water tank 1 to supply the electricity required by the air pump 52. The receiver 50 can receive resonance energy through wireless power transmission and transform the received resonance energy into the form of electricity required for operations of the air pump 52 of the passive device 5. The air pump 52 is an electrically driven air pumping device having an air tube 521. The air tube 521 is in communication with the air pump 52 and extends below the water surface of the water tank 1. Thus, the air pump 52 can draw air and discharge the drawn air into the water tank 1. When the air pump 52 of the passive device 5 is disposed on the water tank 1 and the receiver 50 is within the effective range of the resonance energy transmitted by the transmitter 3, the receiver 50 can receive the resonance energy and transform it into electricity for use by the air pump 52 of the passive device 5. With the air pump 52 drawing air from outside the water tank 1 and pumping the air into the water tank 1 through the air tube 521, the passive device 5 can raise the dissolved oxygen level of the water in the water tank 1.

The above description of the present invention is intended only to illustrate the preferred embodiments but not to limit the scope of the present invention. It is understood that equivalent changes and modifications of the above embodiments can be made without departing from the spirit of the present invention. The scope of the present invention is defined only by the appended claims.

What is claimed is:

1. A water tank structure with wireless power transmission devices, the water tank structure comprising:
a water tank, which is a container structure for holding water;
a passive device, which is an electric device having an electrical load and comprises a receiver, the receiver comprising a receiving circuit and a rectifying circuit; and
a transmitter comprising a power supply, a resonance transmission driving circuit, and a transmitting circuit, the transmitter transmitting electric energy to the receiver through resonance between the transmitter and the receiver,
wherein: the passive device is provided in the water tank; the transmitter is provided at a position where an effective range of resonance energy transmitted by the transmitter covers the receiver; the power supply is a power source for supplying electricity required for operations of the transmitter; the resonance transmission driving circuit is an electric signal regulating circuit for transforming a portion of the electricity provided by the power supply into an electric signal and outputting the electric signal to the transmitting circuit; the transmitting circuit transforms the electric signal generated by the resonance transmission driving circuit into the resonance energy and transmits the resonance energy; the receiving circuit corresponds to the transmitting circuit in terms of electrical resonance characteristics and transforms a resonance signal transmitted by and received from the transmitting circuit into electricity for output; and the rectifying circuit is an electric signal regulating circuit for regulating and transforming the electricity output from the receiving circuit and outputting the electricity in a form required by the electrical load of the passive device.

2. The water tank structure of claim 1, wherein the transmitter is provided at a bottom part, a top end, or a lateral part of the water tank.

3. The water tank structure of claim 1, wherein the transmitter is provided adjacent to the water tank and is located where the effective range of the resonance energy transmitted by the transmitter covers the receiver.

4. The water tank structure of claim 1, wherein the passive device further comprises a light emitting element and a submersible light, the submersible light being a hollow waterproof box structure,
wherein: the submersible light has a light permeable part made of a light permeable material and corresponding in position to the light emitting element; the light emitting element is an electrical load to be electrically driven to emit light, is provided in the submersible light, and corresponds to the light permeable part; and the receiver is provided in the submersible light and electrically connected to the light emitting element of the passive device.

5. The water tank structure of claim 4, wherein the hollow waterproof box structure of the submersible light is composed of an upper cover and a lower cover, the upper cover being provided at a top end of the lower cover to form the hollow waterproof box structure of the submersible light, the light permeable part being provided on the upper cover.

6. The water tank structure of claim 5, wherein the submersible light further comprises an inner box, the inner box being a hollow structure with a through-hole post and being provided between the upper cover and the lower cover, the through-hole post extending upward from a top end of the inner box and corresponding in position to the light permeable part of the upper cover, the through-hole post being formed as a tubular structure penetrated by a central through hole, the light emitting element and the receiver of the passive device being provided in the inner box, light emitted by the light emitting element penetrating the upper cover through the light permeable part by way of the through-hole post.

7. The water tank structure of claim 1, wherein the transmitter further comprises a first member, the first member having a bottom part provided with a bottom cover, the first member forming a transmitter receiving part,
wherein: the first member is an element installed in the water tank; the transmitter receiving part is a hollow structure formed in the first member and has bottom part sealed by the bottom cover; and the power supply, the resonance transmission driving circuit, and the transmitting circuit of the transmitter are provided in the transmitter receiving part of the first member.

8. The water tank structure of claim 7, wherein the first member is located with respect to the water tank in such a way that the receiver, which is provided in the passive device, is within the effective range of the resonance energy transmitted by the transmitter and can receive the resonance energy transmitted by the transmitter.

9. The water tank structure of claim 7, wherein the power supply of the transmitter is an alternating-current power line, and the power supply has an end extending outward and exposed outside the first member in order to electrically connect to a mains electricity system.

10. The water tank structure of claim 1, wherein the passive device further comprises a first ornament having a lower cover,
wherein: the first ornament is provided at a top end of the lower cover such that the first ornament and the lower cover jointly form a hollow waterproof box structure; the first ornament is at least partially made of a light permeable material and has a decorative shape; and the light emitting element and the receiver are provided between the first ornament and the lower cover and correspond to a light permeable portion of the first ornament.

11. The water tank structure of claim 1, wherein the passive device further comprises a second ornament, the second ornament having a lower cover and a plurality of light guide members,
wherein: the second ornament is provided at a top end of the lower cover such that the second ornament and the lower cover jointly form a hollow waterproof box structure; the light guide members, each being a cylinder made of a light conductive material, penetrate and extend out of the second ornament from a position within the second ornament that corresponds to the light emitting element; and the light emitting element and the receiver are provided between the second ornament and the lower cover and correspond to the light guide members of the second ornament.

12. The water tank structure of claim 1, wherein the passive device further comprises a third ornament, the third ornament having a lower cover and a light permeable cover,
wherein: the third ornament is provided at a top end of the lower cover and is a hollow box structure at least partially light-permeable; the light emitting element and the receiver are provided in the third ornament and correspond to a light permeable portion of the third ornament; the light permeable cover is a hollow structure made of a light permeable material and encloses the third ornament; and the light permeable cover comprises a first light permeable cover and a second light permeable cover, the first light permeable cover and the second light permeable cover being half-closed shells and forming a hollow waterproof structure when connected together.

13. The water tank structure of claim 12, wherein the third ornament of the passive device and the light permeable cover of the third ornament form a structure whose specific gravity is close to or less than that the specific gravity of water.

14. The water tank structure of claim 1, wherein the passive device further comprises a submersible pump, the submersible pump being an electrically driven water pumping device and having a water tube and a filter,
wherein: the water tube is in communication with the submersible pump and the filter; the filter is a filtering device provided on the water tank, and water filtered through the filter flows back into the water tank; and the receiver is provided in the submersible pump of the passive device in a sealed and watertight manner and electrically connected to the submersible pump so as to supply electricity required by the submersible pump.

15. The water tank structure of claim 1, wherein the passive device further comprises an air pump, the air pump being an electrically driven air pumping device and having an air tube,
wherein: the air tube is in communication with the air pump and extends above a water surface of the water tank so as for the air pump to draw air and discharge the drawn air into the water tank; and the receiver is provided in the air pump of the passive device in a sealed and watertight manner and electrically connected to the air pump so as to supply electricity required by the air pump.

16. The water tank structure of claim 1, wherein the passive device further comprises an oscillator, the oscillator being a waterproof structure and an electrically driven oscillating device for generating bubbles, the oscillator being configured to generate ultrasonic energy and thereby excite the water in the water tank to form bubbles,
wherein the receiver is provided in and electrically connected to the oscillator so as to supply electricity required by the oscillator.

17. The water tank structure of claim 16, wherein the oscillator of the passive device has an oscillator upper cover and an oscillator lower cover,
wherein the oscillator upper cover and the oscillator lower cover jointly form a waterproof box structure, and the receiver and the oscillator are provided in the box structure formed by the oscillator upper cover and the oscillator lower cover.

18. The water tank structure of claim 1, further comprising a relay, the relay being a waterproof structure and an electric energy transmitting device configured to resonate with the transmitter, the relay receiving the resonance energy transmitted by the transmitter and transmitting the received resonance energy to a remote electric device configured to resonate with the relay and thereby receive the resonance energy,
wherein: the relay comprises a relay circuit, the relay circuit comprising a relay coil configured to receive the resonance energy provided by the resonance transmission driving circuit and transmit the received resonance energy in form of resonance energy; and the relay is provided in the water tank and within the effective range of the resonance energy transmitted by the transmitter, while the receiver of the passive device is disposed within an effective range of the resonance energy transmitted by the relay.

19. The water tank structure of claim 18, wherein the relay further comprises a relay upper cover and a relay lower cover, the relay upper cover being provided at a top end of the relay lower cover such that the relay upper cover and the relay lower cover jointly form a waterproof box structure,
wherein the relay is provided in the box structure formed by the relay upper cover and the relay lower cover.

20. The water tank structure of claim 18, wherein the relay is provided in any element of the water tank.

21. The water tank structure of claim 18, wherein the relay circuit of the relay is arranged in a specific pattern to form a resonance energy field of a specific distribution.

22. The water tank structure of claim 1, wherein the receiver is provided at a bottom part, a top end, or a lateral part of the water tank or in a vicinity of the water tank and is within the effective range of the resonance energy transmitted by the transmitter.

23. The water tank structure of claim 22, wherein the passive device further comprises a water pump, the water pump being an electrically driven water pumping device and having a water tube and a filter,
wherein: the water pump is electrically connected to the receiver and in communication with the filter; the water tube is in communication with the water pump and the water tank; the filter is a filtering device provided on the water tank and configured to draw the water in the water tank and direct the drawn water to the filter; and water filtered through the filter flows back into the water tank.

24. The water tank structure of claim 22, wherein the passive device further comprises an air pump, the air pump being an electrically driven air pumping device provided on the water tank, the air pump having an air tube,
wherein the air tube is in communication with the air pump and extends below a water surface of the water tank so as for the air pump to draw air through the air tube and discharge the drawn air into the water tank.

25. The water tank structure of claim 22, wherein the receiving circuit and the rectifying circuit of the receiver are formed on a flexible circuit board.

26. The water tank structure of claim 22, wherein the receiver as a whole is formed as a waterproof structure.
